(19) United States
(12) Patent Application Publication
(10) Pub. No.: US 2025/0123179 A1
(43) Pub. Date: Apr. 17, 2025

(54) METHOD FOR MEASURING LENS PARAMETER AND DEVICE FOR MEASURING LENS PARAMETER

(71) Applicant: SHENZHEN GOODIX TECHNOLOGY CO., LTD., Shenzhen (CN)

(72) Inventors: Chengfeng LUO, Shenzhen (CN); Chao YUAN, Shenzhen (CN); Xiaoqiang YANG, Shenzhen (CN); Xiaogang QING, Shenzhen (CN)

(73) Assignee: SHENZHEN GOODIX TECHNOLOGY CO., LTD., Shenzhen (CN)

(21) Appl. No.: 18/999,202

(22) Filed: Dec. 23, 2024

Related U.S. Application Data
(63) Continuation of application No. PCT/CN2023/117859, filed on Sep. 8, 2023.

(30) Foreign Application Priority Data
Jul. 21, 2023 (CN) 202310911944.3

(51) Int. Cl. G01M 11/02; G06T 7/13; G06T 7/174

(52) U.S. Cl. CPC G01M 11/0207; G06T 7/13; G06T 7/174

(57) ABSTRACT

The present disclosure provides a method for measuring a lens parameter and a device for measuring a lens parameter. The measuring method includes: acquiring an imaged image of the at least single-sided test pattern of the measuring member formed by the imaging module; obtaining a central imaged image and an edge imaged image based on the imaged image, wherein the central imaged image and the edge imaged image are at least partially non-overlapping, and the central imaged image is closer to a center of the imaged image than the edge imaged image; acquiring a central imaging quality parameter based on the central imaged image, and acquiring an edge imaging quality parameter based on the edge imaged image; and determining the lens parameter of the to-be-measured lens based on the central imaging quality parameter and the edge imaging quality parameter.

### CROSS REFERENCE TO RELATED APPLICATIONS

The present disclosure is a continuation of international application No. PCT/CN2023/117859 filed on Sep. 8, 2023, which claims priority to Chinese Patent Application No. 202310911944.3 titled “METHOD FOR MEASURING LENS PARAMETER AND DEVICE FOR MEASURING LENS PARAMETER” and filed with the China National Intellectual Property Administration on Jul. 21, 2023, both of which are incorporated herein by reference in their entireties.

### TECHNICAL FIELD

The present disclosure relates to the technical field of optical imaging, and more specifically relates to a method for measuring a lens parameter and a device for measuring a lens parameter.

### BACKGROUND

An optical under-display optical fingerprint technology is widely used in a variety of terminal devices. Its principle is to emit light using a screen or in other ways. The light passes through a surface such as the screen or glass, then irradiates on a finger, then passes through the screen and a special optical lens after reflection by the finger, and is received by a sensor under the screen, to implement fingerprint image collection and fingerprint identification.

A fingerprint is imaged using a lens module according to an under-display optical fingerprint technology. Whether the lens module images the fingerprint based on a design value depends on a P value (object distance) and a Q value (image distance) after the lens module is mounted. A difference value ΔQ between an actual Q value and a designed Q value is generally referred to as a defocus amount, and an excessive defocus amount can affect fingerprint image collection and identification.

In view of this, how to provide a method for measuring a lens parameter and a device for measuring a lens parameter with better measurement performance is a technical problem to be urgently solved.

### SUMMARY

Embodiments of the present disclosure provide a method for measuring a lens parameter and a device for measuring a lens parameter, which have better measurement performance for the lens parameter.

In a first aspect, a method for measuring a lens parameter is provided, which is applied to a lens module, wherein a measuring member is provided on an object side of a to-be-measured lens in the lens module, the measuring member has at least single-sided test pattern, an imaging module is provided on an image side of the to-be-measured lens, and the measuring method includes: acquiring an imaged image of the at least single-sided test pattern of the measuring member formed by the imaging module; obtaining a central imaged image and an edge imaged image based on the imaged image, wherein the central imaged image and the edge imaged image are at least partially non-overlapping, and the central imaged image is closer to a center of the imaged image than the edge imaged image; acquiring a central imaging quality parameter based on the central imaged image, and acquiring an edge imaging quality parameter based on the edge imaged image; and determining the lens parameter of the to-be-measured lens based on the central imaging quality parameter and the edge imaging quality parameter.

In a second aspect, a device for measuring a lens parameter is provided, including: a measuring member provided on an object side of a to-be-measured lens and having at least single-sided test pattern; an imaging module provided on an image side of the to-be-measured lens and configured to image the at least single-sided test pattern of the measuring member to form an imaged image; and an image processing module configured to obtain a central imaged image and an edge imaged image based on the imaged image, wherein the central imaged image and the edge imaged image are at least partially non-overlapping, and the central imaged image is closer to a center of the imaged image than the edge imaged image; configured to acquire a central imaging quality parameter based on the central imaged image, and acquire an edge imaging quality parameter based on the edge imaged image; and configured to determine the lens parameter of the to-be-measured lens based on the central imaging quality parameter and the edge imaging quality parameter.

In solutions of the embodiments of the present disclosure, the to-be-measured lens may be provided with the measuring member having at least single-sided test pattern, the at least single-sided test pattern is imaged using the imaging module, and the central imaged image and the edge imaged image may be obtained using a preset algorithm based on the imaged image generated by the imaging module, thereby accurately measuring the lens parameter of the to-be-measured lens using a difference between imaging quality parameters of the central imaged image and the edge imaged image.

### BRIEF DESCRIPTION OF DRAWINGS

FIG. 1 is a schematic assembly diagram of a lens module and a screen overlay applied to an optical fingerprint system provided in an embodiment of the present disclosure.

FIG. 2 is a schematic diagram of a detection device for detecting a lens parameter provided in an embodiment of the present disclosure.

FIG. 3 is a schematic top view of a measuring member provided in an embodiment of the present disclosure.

FIG. 4 is a schematic diagram of an image of at least single-sided test pattern of a measuring member formed by a lens module provided in an embodiment of the present disclosure.

FIG. 5 is a schematic diagram of a curve relationship between a central imaging quality parameter, an edge imaging quality parameter, a central-edge contrast parameter, and a defocus amount ΔQ provided in an embodiment of the present disclosure.

FIG. 6 is a schematic flow block diagram of a method for measuring a lens parameter provided in an embodiment of the present disclosure.

FIG. 7 is a schematic diagram of an imaged image of at least single-sided test pattern of a measuring member formed by some other lens modules provided in an embodiment of the present disclosure.

FIG. 8 is a schematic flow block diagram of another method for measuring a lens parameter provided in an embodiment of the present disclosure.

FIG. 9 is a schematic flow block diagram of another method for measuring a lens parameter provided in an embodiment of the present disclosure.

FIG. 10 is a schematic flow block diagram of a method for acquiring a standard defocus curve of a to-be-measured lens provided in an embodiment of the present disclosure.

FIG. 11 is a schematic flow block diagram of another method for acquiring a standard defocus curve of a to-be-measured lens provided in an embodiment of the present disclosure.

FIG. 12 is a schematic diagram of a standard defocus curve provided in an embodiment of the present disclosure.

FIG. 13 is a schematic structural diagram of a device for measuring a lens parameter provided in an embodiment of the present disclosure.

### DETAILED DESCRIPTION

Technical solutions of embodiments of the present disclosure will be described below with reference to the drawings.

The embodiments of the present disclosure may be applied to a lens module in an optical imaging system. For example, the embodiments of the present disclosure may be applied to a lens module in an optical fingerprint system. Specifically, the lens module may include an optical sensor (also referred to as, e.g., an optical imaging sensor) and a lens. When the lens module is applied to an optical fingerprint system, the lens can guide an optical fingerprint signal to enter the optical sensor, so that the optical sensor can image the optical fingerprint signal to generate a fingerprint image for fingerprint identification or fingerprint detection.

In some embodiments, the above-mentioned lens may include one or more optical lenses, to transmit an optical fingerprint signal formed after reflection or scattering by a finger. Related design of the lens can affect the final fingerprint imaging quality, and then affect the fingerprint identification effects. Therefore, the design of the lens appears to be particularly important in the entire optical fingerprint system.

As a common application scenario, an optical fingerprint system provided in an embodiment of the present disclosure may be applied to smart phones, tablet computers, and other mobile terminals with display screens or other electronic devices (e.g., a door lock). More specifically, in the above electronic devices, the optional fingerprint system may be arranged in a local region or a whole region below a display screen, thus forming an under-display optical fingerprint system.

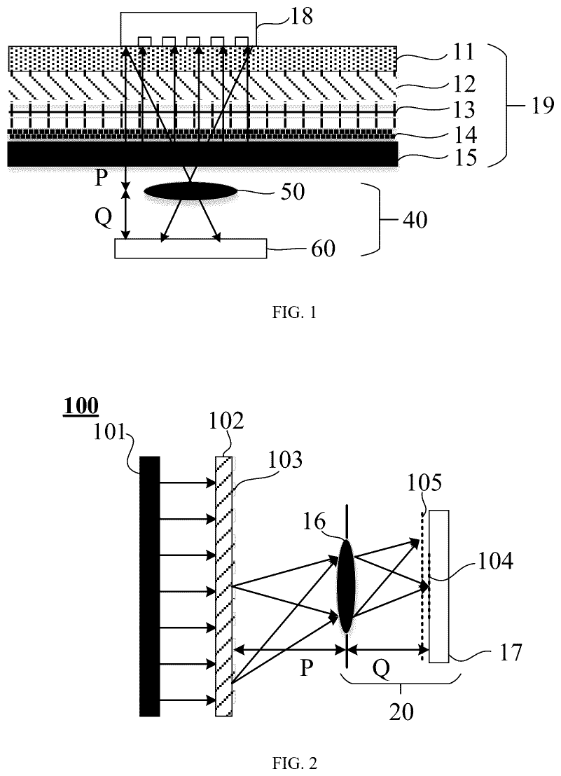

FIG. 1 shows a schematic assembly diagram of a lens module 40 and a screen overlay 19 applied to an optical fingerprint system. As shown in FIG. 1, the screen overlay 19 includes: an upper cover plate 11, a polarizer (POL) 12, a quarter glass slide 13, an organic light-emitting diode (OLED) 14, a lower cover plate 15, and the like. The lens module 40 includes: an optical lens 50 and an imaging module 60. Light is emitted using the organic light-emitting diode 14 or in other ways (for example, an external light source). The light passes through a surface such as the screen overlay 19, then irradiates on a finger 18, passes through the screen overlay 19 and the optical lens 50 after reflection by the finger 18, and is received by the imaging module 60 (e.g., an optical sensor) below the screen overlay 19, to implement fingerprint image collection and fingerprint identification.

Optionally, a distance between a measurement surface of the optical lens 50 and an object surface (e.g., a surface of the finger 18) may be referred to as an object distance P (or referred to as a P value, P0, a preset object distance, a nominal object distance, a designed object distance, a standard object distance, and the like), and a distance between the measurement surface of the optical lens 50 and a surface of the imaging module 60 may be an image distance Q (or referred to as a Q value, Q0, a preset image distance, a nominal image distance, a designed image distance, a standard image distance, and the like). Generally, changes of the P value can change a size of a field of view (FOV), and the P value may be obtained by measuring magnification times of a standard object. A difference value ΔQ between an actual image distance and a designed image distance of the lens module 40 is generally referred to as a defocus amount. An excessive defocus amount can cause the imaged image to become obscure. Since an object, such as the screen overlay 19, that interferes with fingerprint imaging exists in the above optical fingerprint system, the defocus amount exceeding a design value can cause a fingerprint-unrelated image, such as the screen overlay 19, to become distinct, thereby affecting the fingerprint image collection and identification. In order to provide a user with a satisfactory unlocking experience, it is necessary to ensure that the Q value is within a design range. Therefore, it is very important to measure and control a defocus amount of a lens module 20 on a production line.

FIG. 2 shows a schematic diagram of a detection device 100 for detecting a lens parameter. As shown in FIG. 2, the detection device 100 includes a light source 101 and a measuring member 102, wherein at least single-sided test pattern 103 may be provided on one side surface of the measuring member 102 facing the to-be-measured lens 16. In some other embodiments, a test pattern may also be provided on one side surface of the measuring member 102 away from the to-be-measured lens 16. The lens module 20 may be arranged on one side of a surface of the measuring member 102 having the at least single-sided test pattern 103. An optical signal of a light source 101 passes through the measuring member 102. An optical signal carrying information of the at least single-sided test pattern 103 on the surface of the measuring member 102 passes through the to-be-measured lens 16, and is received by the imaging module 17. The imaging module 17 can image the at least single-sided test pattern 103 of the measuring member 102. The imaged image formed by the imaging module 17 can be detected and analyzed, to perform related testing of the lens parameter of the to-be-measured lens 16 of the lens module 20. The lens module 40, the optical lens 50, and the imaging module 17 in the embodiment of FIG. 1 may be referred to for the lens module 20, the to-be-measured lens 16, and the imaging module 17 in the above embodiments.

Optionally, in the detection device 100, a distance between the to-be-measured lens 16 and the measuring member 102 may be a designed object distance (or referred to as a nominal object distance, a nominal P value, P0, and the like). The designed object distance corresponds to a designed image distance (or referred to as a nominal image distance, a nominal Q value, Q0, and the like) of the lens module 20. The designed image distance may specifically be a distance between the to-be-measured lens 16 and the imaging modules 17 in the lens module 20.

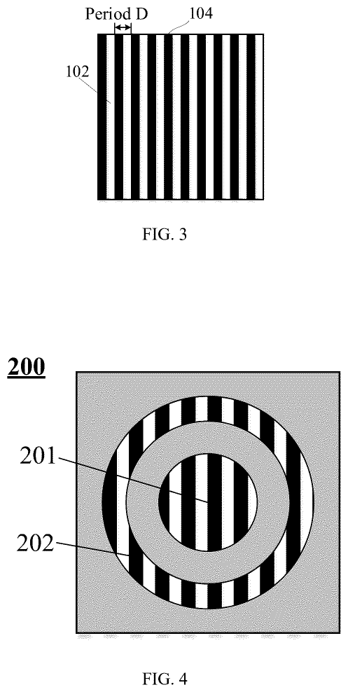

As an example, FIG. 3 shows a schematic top view of the measuring member 102 in FIG. 2. As shown in FIG. 3, at least one single surface of the measuring member 102 forms at least single-sided test pattern 103. The at least single-sided test pattern 103 may be a stripe pattern with a period of D (e.g., a black and white stripe pattern). It is understandable that in some other optional embodiments, the stripe pattern of the at least single-sided test pattern 103 may have no period, that is, spacings between the stripes may vary in size.

Further referring to FIG. 2, since focus positions of a central region 104 and an edge region 105 imaged through the to-be-measured lens 16 are inconsistent, the focus position of the central region 104 is at Q1 (that is, a distance from a lens measurement surface of the to-be-measured lens 16 to a surface of the imaging module 17 is Q1), and the focus position of the edge region 105 is at Q2 (that is, a distance from a lens measurement surface of the to-be-measured lens 16 to a surface of the imaging module 17 is Q2). Therefore, when the defocus amount ΔQ changes, an imaging quality parameter of the central region 104 and an imaging quality parameter of the edge region 105 have different variation trends.

FIG. 4 shows a schematic diagram of an imaged image 200 of at least single-sided test pattern 103 of a measuring member 102 formed by a lens module 20. As shown in FIG. 4, the imaged image 200 is also a stripe pattern, wherein a part of the formed imaged image of the at least single-sided test pattern 103 is omitted in a gray region of FIG. 4. An image formed in the central region 104 is the central imaged image 201, and an image formed in the edge region 105 is the edge imaged image 202. Further referring to FIGS. 2 and 4, a central imaging quality parameter C1 of the central imaged image 201 of the imaged image 200 and an edge imaging quality parameter C2 of the edge imaged image 202 of the imaged image 200 can be computed, and an actual lens parameter of the lens module 20 can be determined based on the C1 and the C2. In some optional embodiments, a ratio (or a sum value, a difference value, and the like) of the edge imaging quality parameter C2 to the central imaging quality parameter C1 may be represented by a central-edge contrast parameter Ratio.

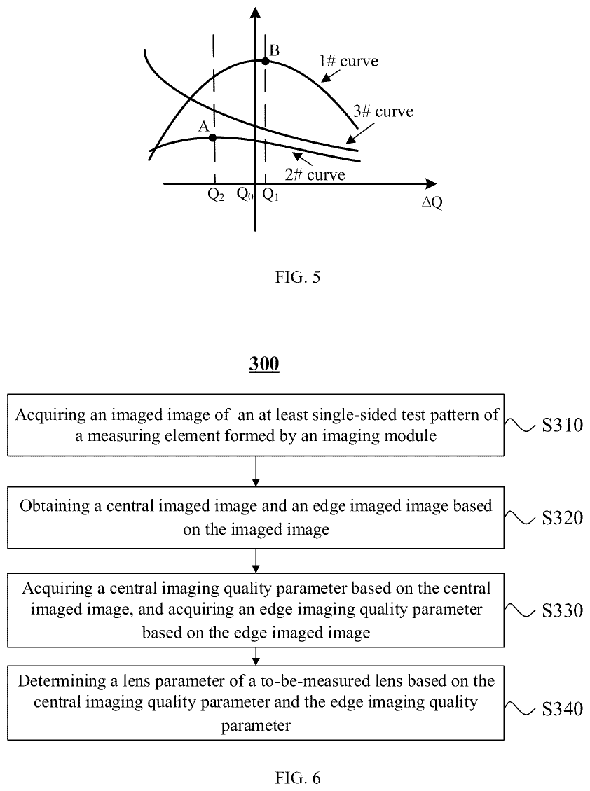

Specifically, FIG. 5 shows a schematic diagram of a curve relationship between a central imaging quality parameter C1, an edge imaging quality parameter C2, a central-edge contrast parameter Ratio, and a defocus amount ΔQ. As shown in FIG. 5, 1 # curve represents a curve relationship between the central imaging quality parameter C1 of the central imaged image 201 and the defocus amount ΔQ of the lens module 20 (that is, in the 1 # curve, the X axis is the defocus amount ΔQ, and the Y axis is the central imaging quality parameter C1), 2 # curve represents a curve relationship between the edge imaging quality parameter C2 of the edge imaged image 202 and the defocus amount ΔQ of the lens module 20 (that is, in the 2 # curve, the X axis is the defocus amount ΔQ, and the Y axis is the edge imaging quality parameter C2), and 3 # curve represents a curve relationship between the central-edge contrast parameter Ratio and the defocus amount ΔQ of the lens module 20 (that is, in the 3 # curve, the X axis is the defocus amount ΔQ, and the Y axis is the Ratio).

As shown in FIG. 5, Q₀ represents the designed image distance, Q1 represents the focus position of the central imaged image 201, and Q2 represents the focus position of the edge imaged image 202. The ΔQ corresponding to maximum value points of the 1 # curve and the 2 # curve is different, wherein the central imaging quality parameter C1 decreases monotonically at both ends of the Q1, the edge imaging quality parameter C2 decreases monotonically at both ends of the Q2, the variation trends of the two with the ΔQ are different; and the central-edge contrast parameter Ratio changes monotonically with the ΔQ. When the ΔQ is positively biased (the imaging module 17 is away from the to-be-measured lens 16), the central imaging quality parameter C1 decreases, the edge imaging quality parameter C2 decreases, and the central-edge contrast parameter Ratio decreases; while when the ΔQ is negatively biased (the imaging module 17 is close to the to-be-measured lens 16), the central imaging quality parameter C1 decreases, the edge imaging quality parameter C2 first increases and then decreases, and the central-edge contrast parameter Ratio increases. Therefore, in some optional embodiments, the C1, the C2, and the Ratio can be combined to determine whether the Q value of the current lens module 20 is positively biased or negatively biased with respect to the Q₀, and determine the current defocus amount ΔQ of the lens module 20.

In order to measure the defocus amount ΔQ and distinguish whether the defocus amount ΔQ is positive or negative, an embodiment of the present disclosure provides a method for measuring a lens parameter, which can perform software measurement on relevant parameters of the lens module 20 (such as the image distance Q value), has excellent measurement performance, and is conducive to improving the manufacturing efficiency, product performance, and product yield of the lens module 20.

FIG. 6 is a schematic flow block diagram of a method 300 for measuring a lens parameter provided in an embodiment of the present disclosure. The measuring method 300 can be applied to the lens module 20 in the above-mentioned embodiments of FIGS. 1 and 2. The lens module 20 may be arranged in the detection device 100 shown in FIG. 2 to facilitate the implementation of the measuring method 300 provided in the embodiment of the present disclosure. The measuring member 102, the at least single-sided test pattern 103, the imaged image 200, the central imaged image 201, the edge imaged image 202, and the like in the above-mentioned embodiments may be referred to for the measuring member, the at least single-sided test pattern, the imaged image, the central imaged image, the edge imaged image, and the like in the following embodiments, which will not be repeated below. In the lens module 20, the measuring member 102 is provided on an object side of the to-be-measured lens 16, the measuring member 102 has at least single-sided test pattern 103, and the imaging module 17 is provided on an image side of the to-be-measured lens 16.

As shown in FIG. 6, the method 300 for measuring a lens parameter includes the following steps.

S310: acquiring an imaged image of at least single-sided test pattern 103 of a measuring member 102 obtained by an imaging module 17.

S320: obtaining a central imaged image 201 and an edge imaged image 202 based on the imaged image 200.

S330: acquiring a central imaging quality parameter C1 based on the central imaged image 201, and acquiring an edge imaging quality parameter C2 based on the edge imaged image 202.

S340: determining a lens parameter of a to-be-measured lens 16 based on the central imaging quality parameter C1 and the edge imaging quality parameter C2.

In an embodiment of the present disclosure, the measuring member 102 may be provided on an object side of the to-be-measured lens 16. The measuring member 102 may be, for example, similar to the measuring member 102 shown in FIG. 2.

In some embodiments, the pattern in the measuring member 102 may be sprayed with ink onto a single-layer board substrate. Optionally, the single-layer board substrate may be, for example, a transparent substrate, such as plastic, acrylic, or glass.

For the measuring method 300 provided in the embodiment of the present disclosure, its executing body may be an image processing module, such as an image processor. The image processing module may be electrically connected to the imaging module 17 in the lens module 20. In some embodiments, the image processing module may be arranged outside the lens module 20, or, in some other embodiments, the image processing module may also be arranged inside the lens module 20 and on the same circuit board as the imaging module 17.

Referring back to FIG. 6, in the step 310, the image processing module may acquire the imaged image 200 of the at least single-sided test pattern 103 of the measuring member 102 formed by the imaging module 17. The imaged image 200 in the above-mentioned embodiment of FIG. 4 may be referred to for the imaged image 200.

In the step 320, specifically, the embodiment of FIG. 4 may be referred to for the central imaged image 201 and the edge imaged image 202. The image processing module can obtain the central imaged image 201 and the edge imaged image 202 in the imaged image 200 in accordance with a preset algorithm. The central imaged image 201 and the edge imaged image 202 are at least partially non-overlapping, and the central imaged image 201 is closer to a center of the imaged image 200 than the edge imaged image 202. According to the above-mentioned embodiment of FIG. 2, the focus positions of the central region 104 and the edge region 105 imaged through the to-be-measured lens 16 are inconsistent. Therefore, the imaging quality parameters of the central imaged image 201 and the edge imaged image 202 are different.

In the step 330, the image processing module can compute the central imaging quality parameter C1 based on the central imaged image 201, and compute the edge imaging quality parameter C2 based on the edge imaged image 202.

In the step 340, the image processing module can determine the lens parameter of the to-be-measured lens 16 based on the central imaging quality parameter C1 and the edge imaging quality parameter C2. Optionally, the lens parameter may include the image distance Q of the to-be-measured lens 16.

With the technical solutions of the above embodiments, the to-be-measured lens 16 may be provided with the measuring member 102 having at least single-sided test pattern 103, the at least single-sided test pattern 103 is imaged using the imaging module 17, and the central imaged image 201 and the edge imaged image 202 may be obtained using the preset algorithm based on the imaged image 200 generated by the imaging module 17, thereby accurately measuring the lens parameter of the to-be-measured lens 16 using a difference between imaging quality parameters of the central imaged image 201 and the edge imaged image 202.

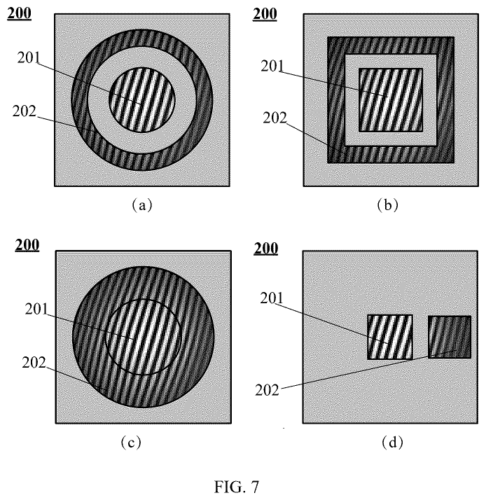

FIG. 7 is a schematic diagram of an imaged image 200 of at least single-sided test pattern 103 of a measuring member 102 formed by some other lens modules 20 provided in an embodiment of the present disclosure.

Further referring to FIGS. 6 and 7, as shown in the figure, in the step 320, the image processing module can demarcate a first computational domain in the imaged image 200 in accordance with the preset algorithm to obtain the central imaged image 201, and can demarcate a second computational domain in the imaged image 200 in accordance with the preset algorithm to obtain the edge imaged image 202. In some optional embodiments, the central imaged image 201 and the edge imaged image 202 are concentric, as shown in FIGS. 7(a)-(c). Specifically, as shown in FIG. 7(a), the central imaged image 201 and the edge imaged image 202 form a circular ring image; as shown in FIG. 7(b), the central imaged image 201 and the edge imaged image 202 form a rectangular ring image; and as shown in FIG. 7(c), the central imaged image 201 and the edge imaged image 202 form a circle. Alternatively, the central imaged image 201 and the edge imaged image 202 may form, e.g., a rectangle.

Preferably, since the shape of the to-be-measured lens 16 is generally a circle, and its imaged image 200 is generally circular, a circular central imaged image 201 may be obtained by demarcating the first computational domain, and a circular ring edge imaged image 202 may be obtained by demarcating the second computational domain, which can improve the accuracy of determining the lens parameter of the to-be-measured lens 16, and is conducive to simplifying the execution difficulty of the measuring method 300 and improving the efficiency of determining the lens parameter of the to-be-measured lens 16.

In some other optional embodiments, in the step 320, the image processing module can demarcate the first computational domain in the imaged image 200 in accordance with the preset algorithm to obtain the central imaged image 201, and can demarcate the second computational domain in the imaged image 200 in accordance with the preset algorithm to obtain the edge imaged image 202. The central imaged image 201 and the edge imaged image 202 are non-concentric, as shown in FIG. 7(d). Specifically, as shown in FIG. 7(d), the central imaged image 201 may be a rectangle, and the edge imaged image 202 may be a rectangle. In this embodiment, specific shapes of the central imaged image 201 and the edge imaged image 202 are not limited.

In some other optional embodiments, in order to make the difference between the central imaging quality parameter C1 and the edge imaging quality parameter C2 more obvious and improve the accuracy of determining the lens parameter of the to-be-measured lens 16, the central imaged image 201 and the edge imaged image 202 may be discontinuous, as shown in FIGS. 7(a), (b), and (d). In some other optional embodiments, the central imaged image 201 and the edge imaged image 202 may be continuous, as shown in FIG. 7(c).

In the above embodiments, different computational domains (such as the first computational domain and the second computational domain) are demarcated to obtain a combination of a plurality of the central imaged images 201 and the edge imaged images 202, thereby improving the flexibility of obtaining the central imaged image 201 and the edge imaged image 202 based on the imaged image 200, and then performing various adjustments based on actual production requirements; the circular central imaged image 201 is obtained by demarcating the first computational domain, and the circular ring edge imaged image 202 is obtained by demarcating the second computational domain, so that the central imaged image 201 and the edge imaged image 202 form a circular ring image, which can improve the accuracy of determining the lens parameter of the to-be-measured lens 16, and is conducive to simplifying the execution difficulty of the measuring method 300 and improving the efficiency of determining the lens parameter of the to-be-measured lens 16.

In some other optional embodiments, the at least single-sided test pattern 103 of the measuring member 102 includes at least one of an equally spaced stripe pattern, a non-equally spaced stripe pattern, a parallel stripe pattern, a non-parallel stripe pattern, a black and white stripe pattern, or a grayscale gradient stripe pattern.

Preferably, the equally spaced black and white stripe pattern has a high contrast ratio, and the imaged image 200 formed by it also has a high contrast ratio. Therefore, in order to simplify the operation difficulty and algorithm execution difficulty of the measuring method 300, the at least single-sided test pattern 103 may be an equally spaced black and white stripe pattern. It is understandable that when the at least single-sided test pattern 103 of the measuring member 102 is an equally spaced black and white stripe pattern, it has the advantages of easy manufacturing, is conducive to quality control, and can ensure the accuracy of determining the lens parameter of the to-be-measured lens 16.

In the above embodiments, the at least single-sided test pattern 103 of the measuring member 102 includes a plurality of different patterns or a combination of a plurality of different patterns, so that the measuring member 102 can be more flexibly selected; and the at least single-sided test pattern 103 is an equally spaced black and white stripe pattern, thereby simplifying the execution difficulty of the measuring method 300, and improving the efficiency of determining the lens parameter of the to-be-measured lens 16.

In some optional embodiments, the central imaging quality parameter C1 may include at least one of a definition, a contrast ratio, a maximum difference value between bright and dark stripes, an image sharpness, a gradient, a Spatial Frequency Response (SFR), or a Modulation Transfer Function (MTF). Likewise, the edge imaging quality parameter C2 may include at least one of a definition, a contrast ratio, a maximum difference value between bright and dark stripes, an image sharpness, a gradient, a Spatial Frequency Response (SFR), or a Modulation Transfer Function (MTF).

In some optional embodiments, the central imaging quality parameter C1 and the edge imaging quality parameter C2 may include the same any of the above parameters or a same combination of the above parameters, that is, the central imaging quality parameter C1 and the edge imaging quality parameter C2 adopt the same computation method, or, the central imaging quality parameter C1 and the edge imaging quality parameter C2 may include different any of the above parameters or a different combination of the above parameters, that is, the central imaging quality parameter C1 and the edge imaging quality parameter C2 adopt different computation methods.

In the above embodiments, the central imaging quality parameter C1 and the edge imaging quality parameter C2 include a plurality of parameters or a combination of a plurality of parameters, thereby improving the flexibility of acquiring the central imaging quality parameters C1 and the edge imaging quality parameter C2, and the lens parameter of the to-be-measured lens 16 is determined based on the plurality of the central imaging quality parameters C1 and the plurality of the edge imaging quality parameters C2, thereby improving the accuracy of the measuring method 300.

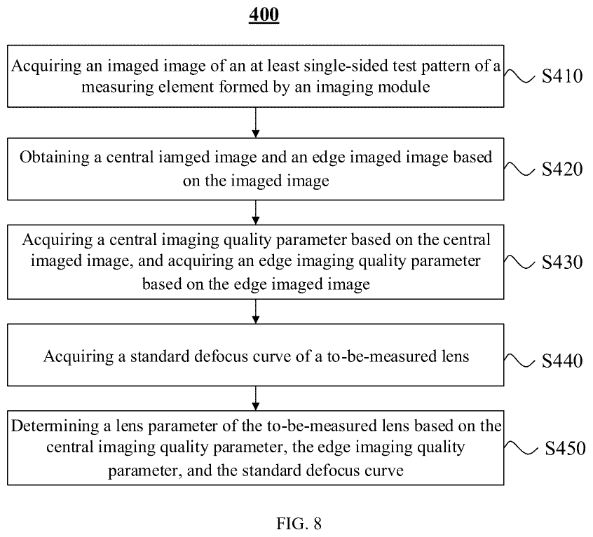

FIG. 8 shows a schematic flow block diagram of another method 400 for measuring a lens parameter provided in an embodiment of the present disclosure. As shown in FIG. 8, the method 400 for measuring a lens parameter includes the following steps.

S410: acquiring an image of at least single-sided test pattern 103 of a measuring member 102 obtained by an imaging module 17.

S420: obtaining a central imaged image 201 and an edge imaged image 202 based on the imaged image 200.

S430: acquiring a central imaging quality parameter C1 based on the central imaged image 201, and acquiring an edge imaging quality parameter C2 based on the edge imaged image 202.

S440: acquiring a standard defocus curve of a to-be-measured lens 16.

S450: determining a lens parameter of the to-be-measured lens 16 based on the central imaging quality parameter C1, the edge imaging quality parameter C2, and the standard defocus curve.

Specifically, the relevant description of the above embodiments may be referred to for relevant technical solutions of the above steps S410-S430, which will not be repeated here. Further referring to FIGS. 8 and 6, the step 340 in the embodiment of FIG. 6 may further include the step 440 and the step 450.

In the step 440, the image processing module can acquire the standard defocus curve of the to-be-measured lens 16. The standard defocus curve may be used to characterize a function relationship between the lens parameters (such as the image distance Q) and the imaging quality parameters (such as the central imaging quality parameter C1 and the edge imaging quality parameter C2) of the to-be-measured lens 16. In some specific embodiments, the standard defocus curve of the to-be-measured lens 16 may be pre-acquired (for example, the standard defocus curve is pre-acquired in a laboratory).

In the step 450, the image processing module may determine the lens parameter of the to-be-measured lens 16 based on the central imaging quality parameter C1, the edge imaging quality parameter C2, and the standard defocus curve.

In the above embodiments, the standard defocus curve is pre-acquired, thereby improving the accuracy and efficiency of determining the lens parameter of the to-be-measured lens 16. Further, the actual step of acquiring the lens parameter of the to-be-measured lens 16 may be executed in a production line or a module factory of the lens module 20. The standard defocus curve is pre-acquired, thereby improving the efficiency of detection and quality control of the lens module 20 in the production line and the module factory of the lens module 20.

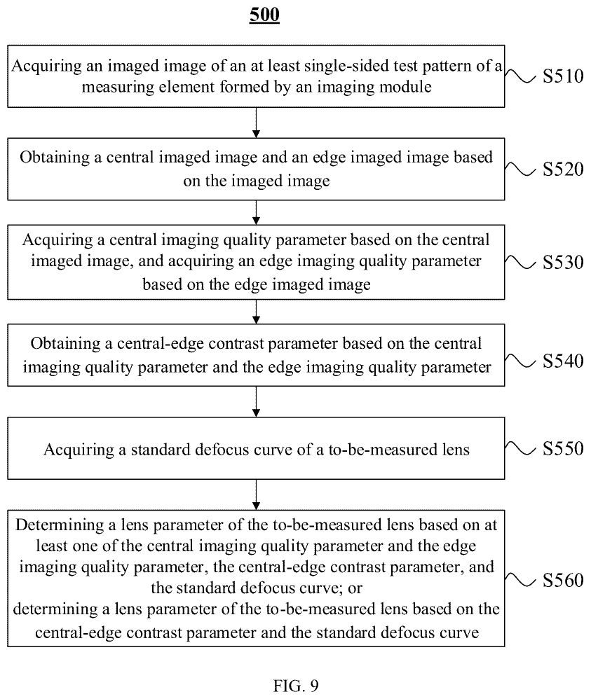

FIG. 9 shows a schematic flow block diagram of another method 500 for measuring a lens parameter provided in an embodiment of the present disclosure. As shown in FIG. 9, the method 500 for measuring a lens parameter includes the following steps.

S510: acquiring an image of at least single-sided test pattern 103 of a measuring member 102 obtained by an imaging module 17.

S520: obtaining a central imaged image 201 and an edge imaged image 202 based on the imaged image 200.

S530: acquiring a central imaging quality parameter C1 based on the central imaged image 201, and acquiring an edge imaging quality parameter C2 based on the edge imaged image 202.

S540: obtaining a central-edge contrast parameter Ratio based on the central imaging quality parameter C1 and the edge imaging quality parameter C2.

S550: acquiring a standard defocus curve of a to-be-measured lens 16.

S560: determining a lens parameter of the to-be-measured lens 16 based on at least one of the central imaging quality parameter C1 and the edge imaging quality parameter C2, the central-edge contrast parameter Ratio, and the standard defocus curve; or determining a lens parameter of the to-be-measured lens 16 based on the central-edge contrast parameter Ratio and the standard defocus curve.

Specifically, the relevant description of the above embodiments may be referred to for relevant technical solutions of the above steps 510-530, and S550, which will not be repeated here.

Further referring to FIGS. 8 and 9, after the step 430, the measuring method 400 in the above embodiment of FIG. 8 may further include the step 540. In the step 540, the image processing module can obtain the central-edge contrast parameter Ratio based on the central imaging quality parameter C1 and the edge imaging quality parameter C2. The central-edge contrast parameter Ratio is computed based on consideration of both the central imaging quality parameter C1 and the edge imaging quality parameter C2, and the central imaging quality parameter C1 and the edge imaging quality parameter C2 respectively reflect the imaging quality difference between the central imaged image 201 and the edge imaged image 200 of the imaged image 200 obtained by the imaging module 17, and further, the imaging quality difference is caused by different focus positions of the to-be-measured lens 16 on an imaging surface of the imaging module 17 (referring to the description in the embodiment of FIG. 2). Therefore, the lens parameter of the to-be-measured lens 16 can be accurately obtained based on the central-edge contrast parameter Ratio.

In the step 560, in some optional embodiments, the lens parameter of the to-be-measured lens 16 may be determined based on at least one of the central imaging quality parameter C1 and the edge imaging quality parameter C2, the central-edge contrast parameter Ratio, and the standard defocus curve; specifically, the lens parameter of the to-be-measured lens 16 may be determined based on the central imaging quality parameter C1, the central-edge contrast parameter Ratio, and the standard defocus curve; or, the lens parameter of the to-be-measured lens 16 may be determined based on the edge imaging quality parameter C2, the central-edge contrast parameter Ratio, and the standard defocus curve. It is understandable that according to the corresponding embodiment of FIG. 5, the central imaging quality parameter C1 changes non-monotonically with the ΔQ (referring to the 1 # curve in FIG. 5), and the edge imaging quality parameter C2 changes non-monotonically with the ΔQ (referring to the 2 # curve in FIG. 5). In this case, the lens parameter of the to-be-measured lens 16 can be accurately determined based on the central-edge contrast parameter Ratio that changes monotonically with the ΔQ (referring to the 3 # curve in FIG. 5).

In some other optional embodiments, the central-edge contrast parameter Ratio changes monotonically with the defocus amount ΔQ (referring to the 3 # curve in FIG. 5). Therefore, in order to improve the efficiency of determining the lens parameter of the to-be-measured lens 16, and simplify the difficulty of the measuring method 500, the lens parameter of the to-be-measured lens 16 can be determined only based on the central-edge contrast parameter Ratio and the standard defocus curve.

In the above embodiments, the central-edge contrast parameter Ratio that changes monotonically with the defocus amount ΔQ is computed, to accurately determine the lens parameter (such as the defocus amount ΔQ and positive/negative bias of the defocus amount ΔQ) of the to-be-measured lens 16, thereby improving the efficiency of determining the lens parameter of the to-be-measured lens 16, and simplifying the testing difficulty of the lens module 20.

The step 540, that is, how to obtain the central-edge contrast parameter Ratio, is described in detail below. Specifically, in some optional embodiments, the central-edge contrast parameter Ratio may be obtained based on a ratio of the edge imaging quality parameter C2 to the central imaging quality parameter C1. The obtaining the central-edge contrast parameter Raito based on the ratio of the edge imaging quality parameter C2 to the central imaging quality parameter C1 includes: first central-edge contrast parameter Ratio1=edge imaging quality parameter C2/central imaging quality parameter C1, or second central-edge contrast parameter Ratio2=central imaging quality parameter C1/edge imaging quality parameter C2. It is understandable that the difference between the above two computation methods is that the first central-edge contrast parameter Ratio1 decreases monotonically with the defocus amount ΔQ, while the second central-edge contrast parameter Ratio2 increases monotonically with the defocus amount ΔQ.

In the above embodiments, the central-edge contrast parameter Ratio is obtained based on the ratio of the edge imaging quality parameter C2 to the central imaging quality parameter C1, and the central-edge contrast parameter Ratio changes more dramatically with the ΔQ (for example, the slope of the curve is larger, and the variation trend of the curve is obvious), thereby improving the accuracy of determining the lens parameter of the to-be-measured lens 16.

Alternatively, in some other optional embodiments, the central-edge contrast parameter Ratio may be obtained based on a sum value of the central imaging quality parameter C1 and the edge imaging quality parameter C1; or, in some other optional embodiments, the central-edge contrast parameter Ratio may be obtained based on a difference value between the central imaging quality parameter C1 and the edge imaging quality parameter C2. Alternatively, in some other optional embodiments, the central-edge contrast parameter Ratio may be obtained based on a product of the central imaging quality parameter C1 and the edge imaging quality parameter C2.

In the above embodiments, the central-edge contrast parameter Ratio is computed based on the sum value, the difference value, or the product of the central imaging quality parameter C1 and the edge imaging quality parameter C2, thereby further reflecting the difference in the focus position of the to-be-measured lens 16 on the imaging surface of the imaging module 17, and then improving the accuracy of obtaining the lens parameter of the to-be-measured lens 16.

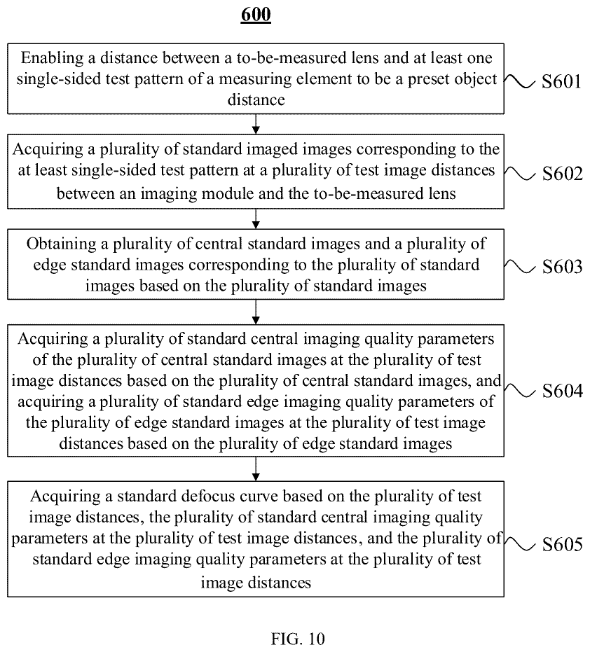

FIG. 10 shows a schematic flow block diagram of a method for acquiring a standard defocus curve of a to-be-measured lens 16 provided in an embodiment of the present disclosure. As shown in FIG. 10, the method 600 for acquiring a standard defocus curve of a to-be-measured lens 16 includes the following steps.

S601: enabling a distance between the to-be-measured lens 16 and at least single-sided test pattern 103 of a measuring member 102 to be a preset object distance.

S602: acquiring a plurality of standard imaged images corresponding to the at least single-sided test pattern 103 at a plurality of test image distances Qₜₑₛₜ between an imaging module 17 and the to-be-measured lens 16.

S603: obtaining a plurality of central standard images and a plurality of edge standard images corresponding to the plurality of standard imaged images based on the plurality of standard imaged images.

S604: acquiring a plurality of standard central imaging quality parameters C01 of the plurality of central standard images at the plurality of test image distances Qₜₑₛₜ based on the plurality of central standard images, and acquiring a plurality of standard edge imaging quality parameters C02 of the plurality of edge standard images at the plurality of test image distances Qₜₑₛₜ based on the plurality of edge standard images.

S605: acquiring a standard defocus curve based on the plurality of test image distances Qₜₑₛₜ, the plurality of standard central imaging quality parameters C01 at the plurality of test image distances Qₜₑₛₜ, and the plurality of standard edge imaging quality parameters C02 at the plurality of test image distances Qₜₑₛₜ.

Further referring to FIGS. 8-10, specifically, the process of acquiring the standard defocus curve of the to-be-measured lens 16 in the above steps 440 and 550 is described in detail in the method 600 for acquiring a standard defocus curve of a to-be-measured lens 16. Further referring to FIG. 2, specifically, in the step 601, the to-be-measured lens 16 of the imaging module 20 may be mounted in a fixed fixture, and the measuring member 102 may be mounted. The enabling the distance between the to-be-measured lens 16 and the at least single-sided test pattern 103 of the measuring member 102 to be the preset object distance may be implemented by manually adjusting the distance between the to-be-measured lens 16 and the at least single-sided test pattern 103 of the measuring member 102, or by automatically adjusting the distance between the to-be-measured lens 16 and the at least single-sided test pattern 103 of the measuring member 102 via the fixture in cooperation with a software algorithm.

In some optional embodiments, since the preset object distance of the to-be-measured lens 16 corresponds to its preset image distance, the step 410 in the embodiment of FIG. 8 and the step 510 in the embodiment of FIG. 9 may include: acquiring, in response to the distance between the to-be-measured lens 16 and the at least single-sided test pattern 103 of the measuring member 102 being the preset object distance, the imaged image 200 of the at least single-sided test pattern 103 of the measuring member 102 obtained by the imaging module 17.

Further, in some other optional embodiments, in order to reduce the difficulty in determining the lens parameter of the to-be-measured lens 16 and improving the efficiency, the preset object distance may be a designed object distance (or referred to as a standard object distance) of the to-be-measured lens 16. The designed object distance may be adjusted adaptively according to actual requirements (for example, different electronic devices in which the lens module 20 is used). The designed object distance can enable the lens module 20 to obtain good imaging effects (such as a high imaging definition).

In some other optional embodiments, the preset object distance may be smaller than, larger than, or equal to the designed object distance of the to-be-measured lens 16.

In the step 602, the image processing module can acquire the plurality of standard imaged images corresponding to the at least single-sided test pattern 103 at the plurality of test image distances Qₜₑₛₜ between the imaging module 17 and the to-be-measured lens 16. the imaged image 200 in the embodiments of FIGS. 4 and 7 may be referred to for the plurality of standard imaged images, which will not be repeated here.

In the step 603, the image processing module can obtain a plurality of central standard images and a plurality of edge standard images corresponding to the plurality of standard imaged images based on the plurality of standard imaged images. It is understandable that the imaging module 17 can obtain the plurality of standard imaged images at the plurality of test image distances Qₜₑₛₜ, the image processing module can demarcate a first computational domain in each standard imaged image among the plurality of standard imaged images in accordance with a preset algorithm to obtain a central standard image, and the image processing module can demarcate a second computational domain in each standard imaged image among the plurality of standard imaged images in accordance with the preset algorithm to obtain an edge standard image, wherein the central standard image and the edge standard image are at least partially non-overlapping, and the central standard image is closer to a center of the standard imaged image than the edge standard image. The demarcation method in the above embodiments of FIGS. 4 and 7 is specifically referred to for the method of demarcating the first computational domain and the second computational domain, which will not be repeated here. Likewise, the image processing module performs same processing on the plurality of standard imaged images, to obtain the plurality of central standard images and the plurality of edge standard images.

In the step 604, the image processing module can acquire the plurality of standard central imaging quality parameters C01 of the plurality of central standard images at the plurality of test image distances Qₜₑₛₜ based on the plurality of central standard images, and then can acquire an array of the plurality of Qₜₑₛₜ and the plurality of C01 with one-to-one correspondence therebetween (this array can be used to form the standard defocus curve). The method of acquiring the central imaging quality parameter C1 in the foregoing embodiments may be referred to for the method of acquiring the standard central imaging quality parameter C01, which will not be repeated here. The image processing module can acquire the plurality of standard edge imaging quality parameters C02 of the plurality of edge standard images at the plurality of test image distances Qₜₑₛₜ based on the plurality of edge standard images, and then can acquire an array of the plurality of Qₜₑₛₜ and the plurality of C02 with one-to-one correspondence therebetween (this array can be used to form the standard defocus curve). The method of acquiring the edge imaging quality parameter C2 in the foregoing embodiments may be referred to for the method of acquiring the standard edge imaging quality parameter C02, which will not be repeated here.

In the step 605, the image processing module can acquire the standard defocus curve based on the plurality of test image distances Qₜₑₛₜ, the plurality of standard central imaging quality parameters C01 at the plurality of test image distances Qₜₑₛₜ, and the plurality of standard edge imaging quality parameters C02 at the plurality of test image distances Qₜₑₛₜ. Specifically, the image processing module obtains the plurality of Qₜₑₛₜ and the plurality of C01 with one-to-one correspondence to the plurality of Qₜₑₛₜ, and obtains the plurality of Qₜₑₛₜ and the plurality of C02 with one-to-one correspondence to the plurality of Qₜₑₛₜ. Therefore, the image processing module can acquire the standard defocus curve at least based on a function relationship between the Qₜₑₛₜ and C01, and a function relationship between the Qₜₑₛₜ and C02.

With the above method 600 for acquiring a standard defocus curve of a to-be-measured lens 16, the standard defocus curve used to determine the lens parameter of the to-be-measured lens 16 can be pre-acquired, thereby improving the accuracy and efficiency of determining the lens parameter of the to-be-measured lens 16.

In some optional embodiments, after the step 601, the method 600 for acquiring a standard defocus curve of a to-be-measured lens 16 may further include: adjusting a distance between the to-be-measured lens 16 and the imaging module 17, to maximize the definition of the standard imaged image. Specifically, in order to more efficiently execute the above step 602, the distance between the to-be-measured lens 16 and the imaging module 17 may first be enabled to be a designed image distance Q₀ (theoretically, in this case, the standard central imaging quality parameter C01 of the central standard image 201 is the largest, and the defocus amount ΔQ=0), so that the distance between the to-be-measured lens 16 and the imaging module 17 can be adjusted more accurately and efficiently, to enable the defocus amount ΔQ of the to-be-measured lens 16 to be positively biased or negatively biased, obtain C01 and C02 when the defocus amount ΔQ of the plurality of to-be-measured lens 16 is positively biased or negatively biased, and avoid repeatedly adjusting the distance between the to-be-measured lens 16 and the imaging module 17, thereby improving the efficiency of the method 600 for acquiring a standard defocus curve of a to-be-measured lens 16, and improving the efficiency of determining the lens parameter of the to-be-measured lens 16. It is understandable that manual ascertainment can be used to maximize the definition of the standard imaged image, or an image algorithm can be used to determine whether the definition of the standard imaged image reaches a maximum value, thereby enabling the distance between the to-be-measured lens 16 and the imaging module 17 to be the designed image distance Q₀.

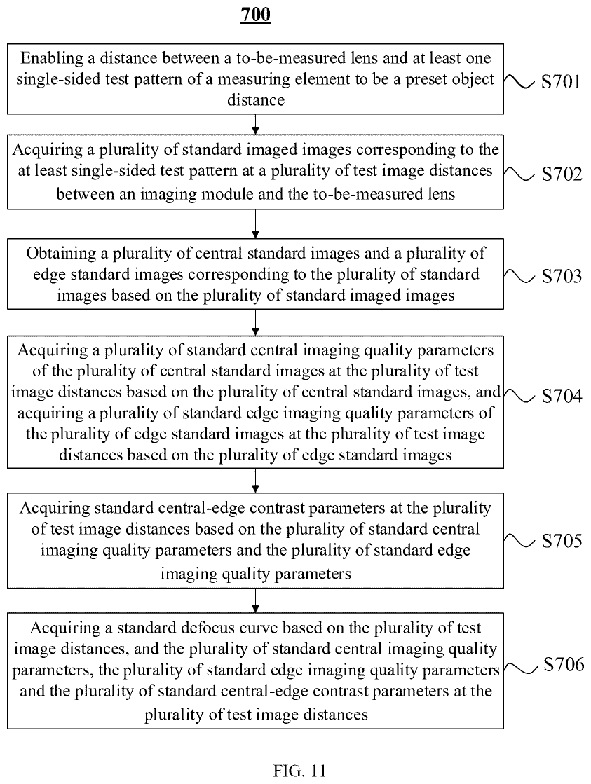

FIG. 11 shows a schematic flow block diagram of another method 700 for acquiring a standard defocus curve of a to-be-measured lens provided in an embodiment of the present disclosure.

S701: enabling a distance between the to-be-measured lens 16 and at least single-sided test pattern 103 of a measuring member 102 to be a preset object distance P.

S702: acquiring a plurality of standard imaged images corresponding to the at least single-sided test pattern 103 at a plurality of test image distances Qₜₑₛₜ between an imaging module 17 and the to-be-measured lens 16.

S703: obtaining a plurality of central standard images and a plurality of edge standard images corresponding to the plurality of standard imaged images based on the plurality of standard imaged images.

S704: acquiring a plurality of standard central imaging quality parameters C01 of the plurality of central standard images at the plurality of test image distances Qₜₑₛₜ based on the plurality of central standard images, and acquiring a plurality of standard edge imaging quality parameters C02 of the plurality of edge standard images at the plurality of test image distances Qₜₑₛₜ based on the plurality of edge standard images.

S705: acquiring standard central-edge contrast parameters Ratio0 at the plurality of test image distances Qₜₑₛₜ based on the plurality of standard central imaging quality parameters C01 and the plurality of standard edge imaging quality parameters C02.

S706: acquiring the standard defocus curve based on the plurality of test image distances Qₜₑₛₜ, and the plurality of standard central imaging quality parameters C01, the plurality of standard edge imaging quality parameters C02 and the plurality of standard central-edge contrast parameters Ratio0 at the plurality of test image distances Qₜₑₛₜ.

Specifically, the relevant description of the above embodiments may be referred to for relevant technical solutions of the above steps 701-704, which will not be repeated here.

In the step 705, further referring to FIG. 2, the standard central-edge contrast parameters Ratio0 at the plurality of test image distances Qₜₑₛₜ can be acquired based on the plurality of standard central imaging quality parameters C01 and the plurality of standard edge imaging quality parameters C02. The Ratio0 is acquired based on consideration of both the standard central imaging quality parameter C01 and the standard edge imaging quality parameter C02, that is, the Ratio0 reflects a difference in imaging quality parameters of a central region 104 and an edge region 105 of the standard imaged image.

In the step 706, the standard defocus curve can be acquired based on the plurality of test image distances Qₜₑₛₜ, and the plurality of standard central imaging quality parameters C01, the plurality of standard edge imaging quality parameters C02 and the plurality of standard central-edge contrast parameters Ratio0 at the plurality of test image distances Qₜₑₛₜ. Specifically, the standard defocus curve may be obtained based on a function relationship between the plurality of test image distances Qₜₑₛₜ and the C01, the C02 and the Ratio0 at the plurality of corresponding test image distances Qₜₑₛₜ.

In some optional embodiments, the plurality of test image distances Qₜₑₛₜ, and the plurality of standard central imaging quality parameters C01, the plurality of standard edge imaging quality parameters C02 and the plurality of standard central-edge contrast parameters Ratio0 at the plurality of test image distances Qₜₑₛₜ may be obtained by simulation, and the standard defocus curve may be obtained by the simulation based on the function relationship between the plurality of test image distances Qₜₑₛₜ and the C01, the C02 and the Ratio0 at the plurality of corresponding test image distances Qₜₑₛₜ.

In some optional embodiments, the standard central-edge contrast parameter Ratio0 may be determined based on at least one of the ratio, the sum value, and the difference value of the plurality of standard central imaging quality parameters C01 and the plurality of standard edge imaging quality parameters C02, and specifically may be determined with reference to the description of the obtaining the central-edge contrast parameter Raito based on the ratio of the edge imaging quality parameter C2 to the central imaging quality parameter C1, obtaining the central-edge contrast parameter Ratio based on the sum value of the central imaging quality parameter C1 and the edge imaging quality parameter C2, and obtaining the central-edge contrast parameter Ratio based on the difference value between the central imaging quality parameter C1 and the edge imaging quality parameter C2 in the above embodiments, which will not be repeated here.

In the above embodiments, the standard central-edge contrast parameter Ratio0 is obtained based on the ratio of the standard edge imaging quality parameter C02 to the standard central imaging quality parameter C01, and the standard central-edge contrast parameter Ratio0 changes more dramatically with the ΔQ (for example, the slope of the curve is larger, and the variation trend of the curve is obvious), thereby improving the accuracy of obtaining the lens parameter of the to-be-measured lens 16. The standard central-edge contrast parameter Ratio0 is computed based on the sum value or the difference value of the standard central imaging quality parameter C01 and the standard edge imaging quality parameter C02, which can further reflect the difference in the focus position of the to-be-measured lens 16 on the imaging surface of the imaging module 17, and then can improve the accuracy of obtaining the lens parameter of the to-be-measured lens 16.

In some optional embodiments, after the step 601 in FIG. 10 and the step 701 in FIG. 11, in order to enable better sampling by the imaging module 17 to obtain an imaged image 200 with a high imaging quality (for example, an image with a high definition and without interference stripes), a mounting angle between the at least single-sided test pattern 103 of the measuring member 102 and the imaging module 17 can be adjusted. Specifically, the at least single-sided test pattern 103 of the measuring member 102 includes a plurality of sub-patterns parallel to a first direction, the imaging module 17 has a second direction, and the second direction is a direction parallel to a particular side of the imaging module 17. The method 600 for acquiring a standard defocus curve of a to-be-measured lens 16 or the method 700 for acquiring a standard defocus curve of a to-be-measured lens 16 may further include: enabling the first direction to have a preset deflection angle with respect to the second direction.

In some optional embodiments, a plane formed by the at least single-sided test pattern of the measuring member is parallel to a sensing surface of the imaging module. The sensing surface can be configured to receive an optical signal. When the imaging module is used in the optical fingerprint system in the above embodiments, the sensing surface can be configured to detect and identify an optical fingerprint signal.

In some optional embodiments, the imaging module 17 includes a rectangular chip, when the rectangular chip is a rectangle-shaped chip, the particular side is a long side or a short side of the rectangular chip, when the rectangular chip is a square chip, the particular side is any side of the rectangular chip; and the preset deflection angle is between-15 degrees and 15 degrees, and is not equal to zero, or, the preset deflection angle is between-75 degrees and 75 degrees, and is not equal to 0.

Preferably, in order to further improve the sampling effects of the imaging module 17 to obtain the imaged image 200 with a high imaging quality, when the rectangular chip is a rectangle-shaped chip, the particular side may be a long side of the rectangular chip.

Preferably, in order to further improve the sampling effects of the imaging module 17 to obtain the imaged image 200 with a high imaging quality, the preset deflection angle is: −75 degrees, +75 degrees, −15 degrees, or 15 degrees.

In the above embodiments, the at least single-sided test pattern 103 of the measuring member 102 and the imaging module 17 have a particular mounting angle, thereby enabling better sampling by the imaging module 17 to obtain the imaged image 200 with a high imaging quality, then accurately acquiring the central imaging quality parameter C1, the edge imaging quality parameter C2, the central-edge contrast parameter Ratio, etc., and accurately acquiring the lens parameter of the to-be-measured lens 16.

The standard defocus curves in the above embodiments will be specifically described below. The standard defocus curve may include the following curves, or a combination of the following curves.

Central defocus curve: The central defocus curve is used to characterize a function relationship between the plurality of test image distances Qₜₑₛₜ of the to-be-measured lens 16 and the plurality of standard central imaging quality parameters C01 of the plurality of central standard images at the plurality of test image distances Qₜₑₛₜ.

Edge defocus curve: The edge defocus curve is used to characterize a function relationship between the plurality of test image distances Qₜₑₛₜ of the to-be-measured lens 16 and the plurality of standard edge imaging quality parameters C02 of the plurality of edge standard images at the plurality of test image distances Qₜₑₛₜ.

Central-edge contrast defocus curve: The central-edge contrast defocus curve is used to characterize a function relationship between the plurality of test image distances Qₜₑₛₜ of the to-be-measured lens 16 and the plurality of standard central-edge contrast parameters Ratio0 at the plurality of test image distances Qₜₑₛₜ.

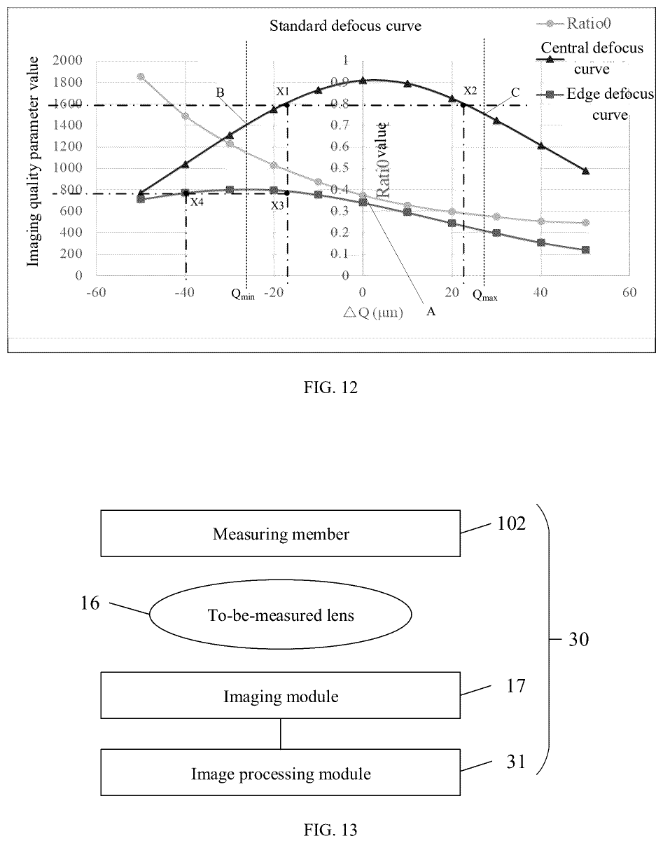

FIG. 12 shows a schematic diagram of a standard defocus curve provided in an embodiment of the present disclosure. As shown in the figure, the standard defocus curve may include the central defocus curve, the edge defocus curve, and the central-edge contrast defocus curve.

In some optional embodiments, the central defocus curve may be obtained based on the plurality of test image distances Qₜₑₛₜ and the plurality of standard central imaging quality parameters C01 at the plurality of test image distances Qₜₑₛₜ. Further, the edge defocus curve may be obtained based on the plurality of test image distances Qₜₑₛₜ and the plurality of standard edge imaging quality parameters C02 at the plurality of test image distances Qₜₑₛₜ. That is, in the above embodiments, the standard defocus curve includes the central defocus curve and the edge defocus curve.

In some optional embodiments, the central defocus curve may be obtained based on the plurality of test image distances Qₜₑₛₜ and the plurality of standard central imaging quality parameters C01 at the plurality of test image distances Qₜₑₛₜ. Further, the central-edge contrast defocus curve may be obtained based on the plurality of test image distances Qₜₑₛₜ and the plurality of standard central-edge contrast parameters Ratio0. That is, in the above embodiments, the standard defocus curve includes the central defocus curve and the central-edge contrast defocus curve.

In some optional embodiments, the edge defocus curve may be obtained based on the plurality of test image distances Qₜₑₛₜ and the plurality of standard edge imaging quality parameters C02 at the plurality of test image distances Qₜₑₛₜ. Further, the central-edge contrast defocus curve may be obtained based on the plurality of test image distances Qₜₑₛₜ and the plurality of standard central-edge contrast parameters Ratio0. That is, in the above embodiments, the standard defocus curve includes the edge defocus curve and the central-edge contrast defocus curve.

In some optional embodiments, the central defocus curve may be obtained based on the plurality of test image distances Qₜₑₛₜ and the plurality of standard central imaging quality parameters C01 at the plurality of test image distances Qₜₑₛₜ. The edge defocus curve may be obtained based on the plurality of test image distances Qₜₑₛₜ and the plurality of standard edge imaging quality parameters C02 at the plurality of test image distances Qₜₑₛₜ. Further, the central-edge contrast defocus curve may be obtained based on the plurality of test image distances Qₜₑₛₜ and the plurality of standard central-edge contrast parameters Ratio0 at the plurality of test image distances Qₜₑₛₜ. That is, in the above embodiments, the standard defocus curve includes the central defocus curve, the edge defocus curve, and the central-edge contrast defocus curve.

In some optional embodiments, the central-edge contrast defocus curve may be obtained based on the plurality of test image distances Qₜₑₛₜ and the plurality of standard central-edge contrast parameters Ratio0 at the plurality of test image distances Qₜₑₛₜ. That is, in the above embodiments, the standard defocus curve includes the central-edge contrast defocus curve.

In the above embodiments, a plurality of different curves or curve combinations are acquired for use as standard defocus curves, thereby improving the flexibility of the method for determining a lens parameter of a to-be-measured lens 16.

In some optional embodiments, the step 560 in the foregoing embodiment of FIG. 9 may further include the following embodiments. Specifically, the determining the lens parameter of the to-be-measured lens 16 based on at least one of the central imaging quality parameter C1 and the edge imaging quality parameter C2, the central-edge contrast parameter Ratio, and the standard defocus curve includes: determining the lens parameter of the to-be-measured lens 16 based on the central imaging quality parameter C1, the edge imaging quality parameter C2, the central defocus curve, and the edge defocus curve.

Specifically, referring to FIG. 12, when the central imaging quality parameter C1 is 1600, there are two corresponding points on the central defocus curve, such as X1 and X2 in the figure. In this case, the edge imaging quality parameter C2 may be combined, for example, the value of C2 is 795, and there are two corresponding points on the edge defocus curve, such as X3 and X4 in the figure. ΔQ corresponding to X3 is closer to ΔQ corresponding to X1 compared to ΔQ corresponding to X4. Therefore, based on X1 and X3, not only can ΔQ of the to-be-measured lens 16 be determined to be negative, but also the magnitude of the ΔQ value can be determined. That is, in the above embodiments, the magnitude and positive/negative bias of the ΔQ may be obtained by image acquisition and measurement once.

Alternatively, in some optional embodiments, the lens parameter of the to-be-measured lens 16 may be determined based on the central imaging quality parameter C1, the central-edge contrast parameter Ratio, the central defocus curve, and the central-edge contrast defocus curve. In the above embodiments, based on the C1, the Ratio, the central defocus curve, and a monotonically changing central-edge contrast defocus curve, not only can the positive/negative bias of the ΔQ of the to-be-measured lens 16 be determined, but also the magnitude of the ΔQ value can be determined. Specifically, as shown in FIG. 12, a point A of the central-edge contrast defocus curve when the defocus amount ΔQ is 0 can be predetermined, that is, the standard central-edge contrast parameter Ratio0 when the defocus amount ΔQ=0. When the measured central-edge contrast parameter Ratio is larger than point A, the ΔQ of the to-be-measured lens 16 can be determined to be negatively biased. In this case, the magnitude of the ΔQ value can be determined based on the central imaging quality parameter C1 and the central defocus curve. Further, as shown in FIG. 12, not only can the standard central-edge contrast parameter Ratio0 be predetermined when the defocus amount ΔQ is 0, but also a lower limit Qₘᵢₙ of the Q value and an upper limit Qₘₐₓ of the Q value of the to-be-measured lens 16 can be acquired by simulation or actual measurement, and values of the standard central imaging quality parameter C01 at the Qₘᵢₙ and the Qₘₐₓ can be determined, to obtain points B and C as shown in FIG. 12. When the measured central-edge contrast parameter Ratio is larger than the point A, and the central imaging quality parameter C1 is larger than the point B, the defocus amount ΔQ is negatively biased, the defocus amount ΔQ is larger than the Qₘᵢₙ, and a specific value of the defocus amount ΔQ can be determined based on the standard defocus curve. For example, the specific value of the defocus amount ΔQ can be determined based on an x-coordinate value of the central imaging quality parameter C1 on the central defocus curve. When the measured Ratio is smaller than the point A, and the central imaging quality parameter C1 is larger than the point C, the defocus amount ΔQ is positively biased, the defocus amount ΔQ is smaller than the Qₘₐₓ, and a specific value of the defocus amount ΔQ can be determined based on the standard defocus curve. For example, the specific value of the defocus amount ΔQ can be determined based on the x-coordinate value of the central imaging quality parameter C1 on the central defocus curve. In this embodiment, the central imaging quality parameter C1 changes more dramatically with the ΔQ (for example, the slope of the curve is larger, and the variation trend of the curve is obvious), thereby improving the accuracy of obtaining the lens parameter of the to-be-measured lens 16.

Alternatively, in some optional embodiments, the lens parameter of the to-be-measured lens 16 may be determined based on the edge imaging quality parameter C2, the central-edge contrast parameter Ratio, the edge defocus curve, and the central-edge contrast defocus curve. In the above embodiments, based on the C2, the Ratio, the edge defocus curve, and the monotonically changing central-edge contrast defocus curve, not only can the positive/negative bias of the ΔQ of the to-be-measured lens 16 be determined, but also the magnitude of the ΔQ value can be determined.

Alternatively, in some optional embodiments, the lens parameter of the to-be-measured lens 16 is determined based on the central imaging quality parameter C1, the edge imaging quality parameter C2, the central-edge contrast parameter Ratio, the central defocus curve, the edge defocus curve, and the central-edge contrast defocus curve. In the above embodiments, based on the C1, the C2, the Ratio, the central defocus curve, the edge defocus curve, and the monotonically changing central-edge contrast defocus curve, not only can the positive/negative bias of the ΔQ of the to-be-measured lens 16 be determined, but also the magnitude of the ΔQ value can be determined.

Referring back to FIG. 9, the step 560 of determining the lens parameter of the to-be-measured lens based on the central-edge contrast parameter Ratio and the standard defocus curve includes: determining the lens parameter of the to-be-measured lens 16 based on the central-edge contrast parameter Ratio and the central-edge contrast defocus curve. Specifically, since the central-edge contrast defocus curve is a monotonically changing curve, only based on the Ratio and the monotonically changing central-edge contrast defocus curve, not only can the positive/negative bias of the ΔQ of the to-be-measured lens 16 be determined, but also the magnitude of the ΔQ value can be determined.

In the above embodiments, the lens parameter of the to-be-measured lens 16 is determined based on the central-edge contrast parameter Ratio and the central-edge contrast defocus curve. The positive/negative bias and the magnitude of the ΔQ value of the to-be-measured lens 16 are determined only based on one of the standard defocus curves, thereby improving the efficiency of determining the lens parameter of the to-be-measured lens 16.

In some optional embodiments, as shown in Table 1 below, the defocus amounts ΔQ of a plurality of lens modules 20 are measured using the measuring method of the embodiment of the present disclosure, and the measurement result is measured ΔQₐ as shown in Table 1. Real defocus amounts of the plurality of lens modules 20 are obtained by actual measurement of slices. The test result is real ΔQ as shown in Table 1. The error reflects an error between the defocus amount ΔQ of the plurality of lens modules 20 measured using the measuring method of the embodiment of the present disclosure and the real defocus amount. As can be seen from Table 1, the defocus amount ΔQ of the lens module 20 can be measured quickly and accurately using the measuring method of the embodiment of the present disclosure.

TABLE 1
Measured ΔQₐ and real ΔQ of the
defocus amount of the lens module

| | | Measured | Real | |
|---|---|---|---|---|
| Lens | | ΔQₐ | ΔQ | Error |
| module | Ratio | (μm) | (μm) | (μm) |
| 1# | 0.37 | 0 | 1 | 1 |
| 2# | 0.31 | 11.5 | 10 | −1.5 |
| 3 # | 0.38 | −1 | −1.5 | −0.5 |
| 4 # | 0.44 | −10 | −8.5 | 1.5 |
| 5 # | 0.27 | 21 | 19 | −2 |

In addition to the method for measuring a lens parameter provided in the above embodiments, an embodiment of the present disclosure further provides a device 30 for measuring a lens parameter.

FIG. 13 shows a schematic structural diagram of a device 30 for measuring a lens parameter provided in an embodiment of the present disclosure.

As shown in FIG. 13, the device 30 for measuring a lens parameter may include: a measuring member 102, an imaging module 17, and an image processing module 31. The measuring member 102 is provided on an object side of a to-be-measured lens 16. The measuring member 102 has at least single-sided test pattern 103 (as shown in the embodiment of FIG. 2). The imaging module 17 is provided on an image side of the to-be-measured lens 16. The imaging module 17 is configured to image the at least single-sided test pattern 103 of the measuring member 102 to form an imaged image 200 (as shown in the embodiments of FIGS. 4 and 7). The image processing module 31 obtains a central imaged image 201 and an edge imaged image 202 based on the imaged image 200, wherein the central imaged image 201 and the edge imaged image 202 are at least partially non-overlapping, and the central imaged image 201 is closer to a center of the imaged image 200 than the edge imaged image 202; the image processing module 31 is configured to acquire a central imaging quality parameter C1 based on the central imaged image 201, and acquire an edge imaging quality parameter C2 based on the edge imaged image 202; and the image processing module 31 is configured to determine a lens parameter of the to-be-measured lens 16 based on the central imaging quality parameter C1 and the edge imaging quality parameter C2.

In the embodiment of the present disclosure, the relevant technical solutions of the measuring member 102, the imaging module 17, and the image processing module in any one of the above method embodiments may be referred to for relevant structures and functions of the measuring member 102, the imaging module 17, and the image processing module 31 in the device 30 for measuring a lens parameter.

The imaging module 17 may include an optical sensor, and the to-be-measured lens 16 images at least single-sided test pattern 103 in the measuring member 102 on the optical sensor, so that the optical sensor generates the imaged image 200 corresponding to the at least single-sided test pattern 103. The image processing module 31 may be electrically connected to the imaging module 17, receives the imaged image 200 generated by the imaging module 17, and processes the imaged image 200.

Optionally, the image processing module 31 can be configured to execute the method for measuring a lens parameter provided in any one of the above embodiments, so as to measure the lens parameter of the to-be-measured lens 16.

In some optional embodiments, in order to enable better sampling by the imaging module 17 to obtain an image 200 with a high imaging quality, a mounting angle between the at least single-sided test pattern 103 of the measuring member 102 and the imaging module 17 can be adjusted. Specifically, the at least single-sided test pattern 103 of the measuring member 102 includes a plurality of sub-patterns parallel to a first direction, the imaging module 17 has a second direction, the second direction is a direction parallel to a particular side of the imaging module 17, and the first direction has a preset deflection angle with respect to the second direction.

In some optional embodiments, a plane formed by the at least single-sided test pattern of the measuring member is parallel to a sensing surface of the imaging module. The sensing surface can be configured to receive an optical signal. When the imaging module is used in the optical fingerprint system in the above embodiments, the sensing surface can be configured to detect and identify an optical fingerprint signal.

In some optional embodiments, the imaging module 17 includes a rectangular chip, when the rectangular chip is a rectangle-shaped chip, the particular side is a long side or a short side of the rectangular chip, when the rectangular chip is a square chip, the particular side is any side of the rectangular chip; and the preset deflection angle is between-15 degrees and 15 degrees, and is not equal to zero, or, the preset deflection angle is between-75 degrees and 75 degrees, and is not equal to 0.

Preferably, in order to further improve the sampling effects of the imaging module 17 to obtain the imaged image 200 with a high imaging quality, when the rectangular chip is a rectangle-shaped chip, the particular side may be a long side of the rectangular chip.

In the above embodiments, the at least single-sided test pattern 103 of the measuring member 102 and the imaging module 17 have a particular mounting angle, thereby enabling better sampling by the imaging module 17 to obtain the imaged image 200 with a high imaging quality, then accurately acquiring the central imaging quality parameter C1, the edge imaging quality parameter C2, the central-edge contrast parameter Ratio, etc., and accurately acquiring the lens parameter of the to-be-measured lens 16.

In some embodiments, the imaging module 17 and the to-be-measured lens 16 can be configured to form a lens module 20 in an optical fingerprint apparatus. The optical fingerprint apparatus can be arranged below a display screen of an electronic device to form an under-display optical fingerprint apparatus.

It should be noted that the image processing module in the above embodiments of the disclosure may be, for example, an image processor, and the image processor may be an integrated circuit chip with a signal processing capability. In an implementation process, steps of the above method embodiments may be completed by an integrated logic circuit of hardware in the processor or instructions in the form of software. The above processor may be a general-purpose processor, a digital signal processor (DSP), an application specific integrated circuit (ASIC), a field programmable gate array (FPGA) or other programmable logic devices, a discrete gate or transistor logic device, or a discrete hardware component, and can implement or execute the methods, steps, and logical block diagrams disclosed in the embodiments of the present disclosure. The general-purpose processor may be a microprocessor or the processor may also be any conventional processor or the like. The steps of the method disclosed in the embodiments of the present disclosure may be directly embodied as being executed and completed by a hardware decoding processor, or being executed and completed by a combination of hardware and software modules in the decoding processor. The software module may be located in a mature storage medium in the art, such as a random-access memory, a flash memory, a read-only memory, a programmable read-only memory or an electrically erasable programmable memory, or a register. The storage medium is located in the memory. The processor reads information in the memory, and completes the steps of the above method in combination with its hardware.

An embodiment of the present disclosure further provides a computer-readable storage medium that stores one or more programs. The one or more programs include instructions. When executed by a processor in an electronic device, the instructions can cause the processor to execute the method in any one of the above embodiments.

An embodiment of the present disclosure further provides a chip. The chip includes an input/output interface, at least one processor, at least one memory, and a bus. The at least one memory is configured to store instructions. The at least one processor is configured to invoke the instructions in the at least one memory to execute the method in any one of the above embodiments.

It should be understood that the formulas in the embodiments of the present disclosure are only examples, and do not limit the scope of the embodiments of the present disclosure. Each formula can be modified, and these modifications should also be encompassed within the scope of protection of the present disclosure.

It should be further understood that in the embodiments of the present disclosure, the magnitudes of the sequence numbers of the processes do not mean the execution sequence. The execution sequence of the processes should be determined based on functions and internal logics thereof, and should not impose any limitation on the implementation processes of the embodiments of the present disclosure.

It should be further understood that the embodiments described in this specification may be implemented individually, or may be implemented in combination, which is not limited in the embodiments of the present disclosure.

Unless otherwise stated, all technical terms and scientific terms used in the embodiments of the present disclosure have the same meanings as commonly understood by those skilled in the art of the present disclosure. The terms used in the present disclosure are only for the purpose of describing specific embodiments, and are not intended to limit the scope of the present disclosure. The term “and/or” used in the present disclosure includes any and all combinations of one or more of the associated listed items.

As will be appreciated by those of ordinary skills in the art, the example modules and algorithm steps described with reference to the embodiments disclosed herein can be implemented by electronic hardware, or by a combination of computer software and electronic hardware. Whether these functions are executed by hardware or software depends on particular applications and design constraints of the technical solutions. Those skilled in the art may implement described functions for each specific application using different methods, but such implementation should not be considered as falling beyond the scope of the present disclosure.

While merely specific embodiments of the present disclosure are provided above, the scope of protection of the present disclosure is not limited to the specific embodiments. Any person skilled in the art can easily conceive of alterations or replacements within the technical scope disclosed in the present disclosure. All these alterations or replacements should be encompassed within the scope of protection of the present disclosure. Therefore, the scope of protection of the present disclosure should be determined by the scope of protection of the appended claims.

What is claimed is:

1. A method for measuring a lens parameter, being applied to a lens module, wherein a measuring member is provided on an object side of a to-be-measured lens in the lens module, the measuring member has an at least single-sided test pattern, and an imaging module is provided on an image side of the to-be-measured lens, the measuring method comprising:
acquiring an imaged image of the at least single-sided test pattern of the measuring member formed by the imaging module;
obtaining a central imaged image and an edge imaged image based on the imaged image, wherein the central imaged image and the edge imaged image are at least partially non-overlapping, and the central imaged image is closer to a center of the imaged image than the edge imaged image;
acquiring a central imaging quality parameter based on the central imaged image, and acquiring an edge imaging quality parameter based on the edge imaged image; and
determining the lens parameter of the to-be-measured lens based on the central imaging quality parameter and the edge imaging quality parameter.

2. The measuring method according to claim 1, wherein the obtaining the central imaged image and the edge imaged image based on the imaged image comprises:
demarcating a first computational domain in the imaged image to obtain the central imaged image; and
demarcating a second computational domain in the imaged image to obtain the edge imaged image, wherein the central imaged image and the edge imaged image are concentric, and the central imaged image and the edge imaged image at least form any one of: a circular ring image, a rectangular ring image, a circular image, or a rectangular image.

3. The measuring method according to claim 1, wherein the obtaining the central imaged image and the edge imaged image based on the imaged image comprises:
demarcating a first computational domain in the imaged image to obtain the central imaged image; and
demarcating a second computational domain in the imaged image to obtain the edge imaged image, wherein the central imaged image and the edge imaged image are non-concentric.

4. The measuring method according to claim 1, wherein the determining the lens parameter of the to-be-measured lens based on the central imaging quality parameter and the edge imaging quality parameter comprises:
acquiring a standard defocus curve of the to-be-measured lens; and
determining the lens parameter of the to-be-measured lens based on the central imaging quality parameter, the edge imaging quality parameter, and the standard defocus curve.

5. The measuring method according to claim 4, wherein after the acquiring the central imaging quality parameter based the central imaged image and acquiring the edge imaging quality parameter based on the edge imaged image, the measuring method further comprises:
obtaining a central-edge contrast parameter based on the central imaging quality parameter and the edge imaging quality parameter;
wherein the determining the lens parameter of the to-be-measured lens based on the central imaging quality parameter, the edge imaging quality parameter, and the standard defocus curve comprises:
determining the lens parameter of the to-be-measured lens based on at least one of the central imaging quality parameter and the edge imaging quality parameter, the central-edge contrast parameter, and the standard defocus curve; or
determining the lens parameter of the to-be-measured lens based on the central-edge contrast parameter and the standard defocus curve.

6. The measuring method according to claim 5, wherein the obtaining the central-edge contrast parameter based on the central imaging quality parameter and the edge imaging quality parameter comprises:
obtaining the central-edge contrast parameter based on a ratio of the edge imaging quality parameter to the central imaging quality parameter; or
obtaining the central-edge contrast parameter based on a sum value of the central imaging quality parameter and the edge imaging quality parameter; or
obtaining the central-edge contrast parameter based on a difference value between the central imaging quality parameter and the edge imaging quality parameter.

7. The measuring method according to claim 6, wherein the acquiring the standard defocus curve of the to-be-measured lens comprises:
enabling a distance between the to-be-measured lens and the at least single-sided test pattern of the measuring member to be a preset object distance;
acquiring a plurality of standard imaged images corresponding to the at least single-sided test pattern at a plurality of test image distances between the imaging module and the to-be-measured lens;
obtaining a plurality of central standard images and a plurality of edge standard images corresponding to the plurality of standard images based on the plurality of standard imaged images, wherein the plurality of central standard images and the plurality of edge standard images are at least partially non-overlapping, and the plurality of central standard images are closer to centers of the plurality of standard imaged images than the plurality of edge standard images;
acquiring a plurality of standard central imaging quality parameters of the plurality of central standard images at the plurality of test image distances based on the plurality of central standard images, and acquiring a plurality of standard edge imaging quality parameters of the plurality of edge standard images at the plurality of test image distances based on the plurality of edge standard images; and
acquiring the standard defocus curve based on the plurality of test image distances, the plurality of standard central imaging quality parameters at the plurality of test image distances, and the plurality of standard edge imaging quality parameters at the plurality of test image distances.

8. The measuring method according to claim 7, wherein the measuring method further comprises acquiring standard central-edge contrast parameters at the plurality of test image distances based on the plurality of standard central imaging quality parameters and the plurality of standard edge imaging quality parameters;
wherein the acquiring the standard defocus curve based on the plurality of test image distances, the plurality of standard central imaging quality parameters at the plurality of test image distances, and the plurality of standard edge imaging quality parameters at the plurality of test image distances comprises:
acquiring the standard defocus curve based on the plurality of test image distances, and the plurality of standard central imaging quality parameters, the plurality of standard edge imaging quality parameters and the plurality of standard central-edge contrast parameters at the plurality of test image distances.

9. The measuring method according to claim 8, wherein the acquiring the standard central-edge contrast parameters at the plurality of test image distances based on the plurality of standard central imaging quality parameters and the plurality of standard edge imaging quality parameters comprises:
determining the standard central-edge contrast parameters based on at least one of the ratio, the sum value, and the difference value of the plurality of standard central imaging quality parameters and the plurality of standard edge imaging quality parameters; and wherein the standard defocus curve comprises:
a central defocus curve and an edge defocus curve; or
the central defocus curve and a central-edge contrast defocus curve; or
the edge defocus curve and the central-edge contrast defocus curve; or
the central defocus curve, the edge defocus curve, and the central-edge contrast defocus curve; or
the central-edge contrast defocus curve;
wherein the central defocus curve is used to characterize a function relationship between the plurality of test image distances of the to-be-measured lens and the plurality of standard central imaging quality parameters of the plurality of central standard images at the plurality of test image distances, the edge defocus curve is used to characterize a function relationship between the plurality of test image distances of the to-be-measured lens and the plurality of standard edge imaging quality parameters of the plurality of edge standard images at the plurality of test image distances, and the central-edge contrast defocus curve is used to characterize a function relationship between the plurality of test image distances of the to-be-measured lens and the standard central-edge contrast parameters at the plurality of test image distances.

10. The measuring method according to claim 9, wherein the determining the lens parameter of the to-be-measured lens based on at least one of the central imaging quality parameter and the edge imaging quality parameter, the central-edge contrast parameter, and the standard defocus curve comprises:
determining the lens parameter of the to-be-measured lens based on the central imaging quality parameter, the edge imaging quality parameter, the central defocus curve, and the edge defocus curve; or
determining the lens parameter of the to-be-measured lens based on the central imaging quality parameter, the central-edge contrast parameter, the central defocus curve, and the central-edge contrast defocus curve; or
determining the lens parameter of the to-be-measured lens based on the edge imaging quality parameter, the central-edge contrast parameter, the edge defocus curve, and the central-edge contrast defocus curve; or
determining the lens parameter of the to-be-measured lens based on the central imaging quality parameter, the edge imaging quality parameter, the central-edge contrast parameter, the central defocus curve, the edge defocus curve, and the central-edge contrast defocus curve.

11. The measuring method according to claim 9, wherein the determining the lens parameter of the to-be-measured lens based on the central-edge contrast parameter and the standard defocus curve comprises:
determining the lens parameter of the to-be-measured lens based on the central-edge contrast parameter and the central-edge contrast defocus curve.

12. The measuring method according to claim 7, wherein the acquiring the imaged image of the at least single-sided test pattern of the measuring member formed by the imaging module comprises:
acquiring, in response to the distance between the to-be-measured lens and the at least single-sided test pattern of the measuring member being the preset object distance, the imaged image of the at least single-sided test pattern of the measuring member formed by the imaging module; and wherein the preset object distance is a designed object distance of the to-be-measured lens.

13. The measuring method according to claim 7, wherein after the enabling the distance between the to-be-measured lens and the at least single-sided test pattern of the measuring member to be the preset object distance, the measuring method further comprises:
adjusting a distance between the to-be-measured lens and the imaging module, so that a definition of the standard imaged image reaches a maximum value.

14. The measuring method according to claim 1, wherein the at least single-sided test pattern of the measuring member comprises at least one of an equally spaced stripe pattern, a non-equally spaced stripe pattern, a parallel stripe pattern, a non-parallel stripe pattern, a black and white stripe pattern, or a grayscale gradient stripe pattern.

15. The measuring method according to claim 14, wherein the at least single-sided test pattern of the measuring member comprises a plurality of sub-patterns parallel to a first direction, a plane formed by the at least one single-sided test pattern is parallel to a sensing surface of the imaging module, the imaging module has a second direction, the second direction is a direction parallel to a particular side of the imaging module, and after a distance between the to-be-measured lens and the at least single-sided test pattern of the measuring member is a preset object distance, the measuring method further comprises: enabling the first direction to have a preset deflection angle with respect to the second direction.

16. The measuring method according to claim 15, wherein the imaging module comprises a rectangular chip, when the rectangular chip is a rectangle-shaped chip, the particular side is a long side or a short side of the rectangular chip, when the rectangular chip is a square chip, the particular side is any side of the rectangular chip; and the preset deflection angle is between −75 degrees and 75 degrees, and is not equal to 0, or, the preset deflection angle is between-15 degrees and 15 degrees, and is not equal to zero.

17. A device for measuring a lens parameter, comprising:
a measuring member provided on an object side of a to-be-measured lens and having at least single-sided test pattern;
an imaging module provided on an image side of the to-be-measured lens and configured to image the at least single-sided test pattern of the measuring member to form an imaged image; and
an image processing module configured to obtain a central imaged image and an edge imaged image based on the imaged image, wherein the central imaged image and the edge imaged image are at least partially non-overlapping, and the central imaged image is closer to a center of the imaged image than the edge imaged image; configured to acquire a central imaging quality parameter based on the central imaged image, and acquire an edge imaging quality parameter based on the edge imaged image; and configured to determine the lens parameter of the to-be-measured lens based on the central imaging quality parameter and the edge imaging quality parameter.

18. The measuring device according to claim 17, wherein the at least single-sided test pattern of the measuring member comprises a plurality of sub-patterns parallel to a first direction, a plane formed by the at least single-sided test pattern is parallel to a sensing surface of the imaging module, the imaging module has a second direction, the second direction is a direction parallel to a particular side of the imaging module, and the first direction has a preset deflection angle with respect to the second direction.

19. The measuring device according to claim 18, wherein the imaging module comprises a rectangular chip, when the rectangular chip is a rectangle-shaped chip, the particular side is a long side or a short side of the rectangular chip, when the rectangular chip is a square chip, the particular side is any side of the rectangular chip; and the preset deflection angle is between −75 degrees and 75 degrees, and is not equal to 0, or, the preset deflection angle is between-15 degrees and 15 degrees, and is not equal to zero.

20. The measuring device according to claim 17, wherein the to-be-measured lens and the imaging module are configured to form a lens module in an optical fingerprint apparatus.
